(19) United States
(12) Patent Application Publication
(10) Pub. No.: US 2007/0100689 A1
(43) Pub. Date: May 3, 2007

(54) Selection and/or application of special ad styles

(76) Inventors: Brian Axe, San Francisco, CA (US); Shannon Bauman, Mountain View, CA (US); Nathan Lucash, San Francisco, CA (US); Susan Wojcicki, Los Altos, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/263,567

(22) Filed: Oct. 31, 2005

(51) Int. Cl. G06Q 30/00

(52) U.S. Cl. 705/14

(57) ABSTRACT

An end user's enjoyment of online ads may be increased, a likelihood that an end user will notice an ad may be increased, performance (e.g., selection rate) of an ad may be increase, brand association between an advertising network and an ad may be increased, and/or brand association between a search engine may be increased and an ad by controlling the application of enhanced features to ads (e.g., conditioned upon a date).

### § 1. BACKGROUND OF THE INVENTION

§ 1.1 Field of the Invention

The present invention concerns advertising, such as online advertising for example. In particular, the present invention concerns enhancing response rates, branding, and/or end user appreciation of online advertisements.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif. (referred to as “Google”), delivers ads targeted to keywords from search queries. Similarly, content targeted ad delivery systems have been proposed. For example, U.S. patent application Ser. No. 10/314,427 (incorporated herein by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and U.S. patent application Ser. No. 10/375,900 (incorporated by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular. Moreover, advertising using other targeting techniques, and even untargeted online advertising, has become increasingly popular.

U.S. patent application Ser. No. 10/610,350 (incorporated herein by reference and referred to as “the '350 application”), filed: Jun. 30, 2003, titled “USING ENHANCED AD FEATURES TO INCREASE COMPETITION IN ONLINE ADVERTISING”, and listing Eric Veach as the inventor encourages competition in an online advertising system in which advertisers compete with each other for advertising space. There may be multiple advertising positions available, where the placement of advertisements is determined by an auction. The '350 application may increase competition in online advertising by presenting some advertisements with enhanced features. These enhanced features create an incentive for which advertisers can compete, thereby increasing the effectiveness, usefulness and/or profitability of the advertising system. The application of enhanced features may be determined using at least one or more of pricing information, performance information and advertising information.

Although online advertising networks, particularly those that endeavor to serve relevant ads, have been very popular, they could be improved. For example, it would be useful to better control the application of enhanced features to ads.

### § 2. SUMMARY OF THE INVENTION

Embodiments consistent with the present invention may improve an end user's enjoyment of online ads, increase a likelihood that an end user will notice an ad, increase performance (e.g., selection rate) of an ad, increase brand association between an advertising network and an ad, increase brand association between an advertising network and a content owner (e.g., Web publisher), and/or increase brand association between a search engine and an ad by controlling the application of enhanced features to ads (e.g., conditioned upon a date).

### § 3. BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIGS. 3A-3E are special logos that have been used on the Google search engine home page to celebrate America's Independence day.

FIGS. 4A-3E are special logos that have been used on the Google search engine home page to celebrate Halloween.

FIGS. 5A-5D are special logos that have been used on the Google search engine home page to celebrate Father's Day.

FIGS. 6A-6E are special logos that have been used on the Google search engine home page to celebrate Mother's Day.

FIGS. 7A-7E are special logos that have been used on the Google search engine home page to celebrate Valentines Day.

FIGS. 8A-8D are special logos that have been used on the Google search engine home page to celebrate Thanksgiving.

FIG. 9 is a special logos that has been used on the Google search engine home page to celebrate Vincent van Gogh's birthday.

FIG. 10 is a special logo that has been used on the Google search engine home page to celebrate Leonardo da Vinci's birthday.

FIG. 11 is a special logo that has been used on the Google search engine home page to celebrate Swiss National day.

FIG. 12 is a special logo that has been used on the Google search engine home page to celebrate Korean Liberation day.

FIGS. 13A and 13B are special logos that have been used on the Google search engine home page to celebrate Canada day.

FIGS. 14A and 14B are special logos that have been used on the Google search engine home page to celebrate Bastille day.

FIGS. 15A and 15B are special logos that have been used on the Google search engine home page to celebrate Children's day and Shichi-go-san day in Japan.

FIGS. 16A-16D are special logos that have been used on the Google search engine home page to celebrate Saint Patrick's day.

FIGS. 17A-17D are special logos that have been used on the Google search engine home page to celebrate Chinese New Years.

FIGS. 18A-18E are special logos that have been used on the Google search engine home page to celebrate Earth day.

FIG. 19 is a special logo that has been used on the Google search engine home page to celebrate Water day.

FIGS. 20A-20E are special logos that have been used on the Google search engine home page to celebrate New Year's day.

FIGS. 21A and 21B are special logos that have been used on the Google search engine home page to encourage US voters to vote.

FIG. 22 is a special logo that have been used on the Google search engine home page to celebrate Groundhog day.

FIG. 23 is a special logo that has been used on the Google search engine home page to celebrate the World Cup Soccer tournament.

FIG. 24 is a special logo that has been used on the Google search engine home page to celebrate Easter.

FIG. 25 is a special logo that has been used on the Google search engine home page to celebrate International Woman's day.

FIG. 26 is a flow diagram of an exemplary method for applying formatting or styling to online ads in a manner consistent with the present invention.

FIGS. 27A-27C illustrate examples of how different Independence Day graphical elements may be applied to ads.

FIG. 28 illustrates examples of how different Halloween graphical elements may be applied to ads as “watermarks.”

FIG. 29 is a block diagram of apparatus that may be used to perform at least some operations, and store at least some information, in a manner consistent with the present invention.

### § 4. DETAILED DESCRIPTION

The present invention may involve novel methods, apparatus, message formats, and/or data structures for improving ads, such as those used in an online advertising system for example. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. In the following, “information” may refer to the actual information, or a pointer to, or a location of, such information. Thus, the present invention is not intended to be limited to the embodiments shown and the inventors regard their invention to include any patentable subject matter described.

In the following definitions of terms that may be used in the specification are provided in § 4.1. Then, environments in which, or with which, the present invention may operate are described in § 4.2. Exemplary embodiments of the present invention are described in § 4.3. Finally, some conclusions regarding the present invention are set forth in § 4.4.

### § 4.1 DEFINITIONS

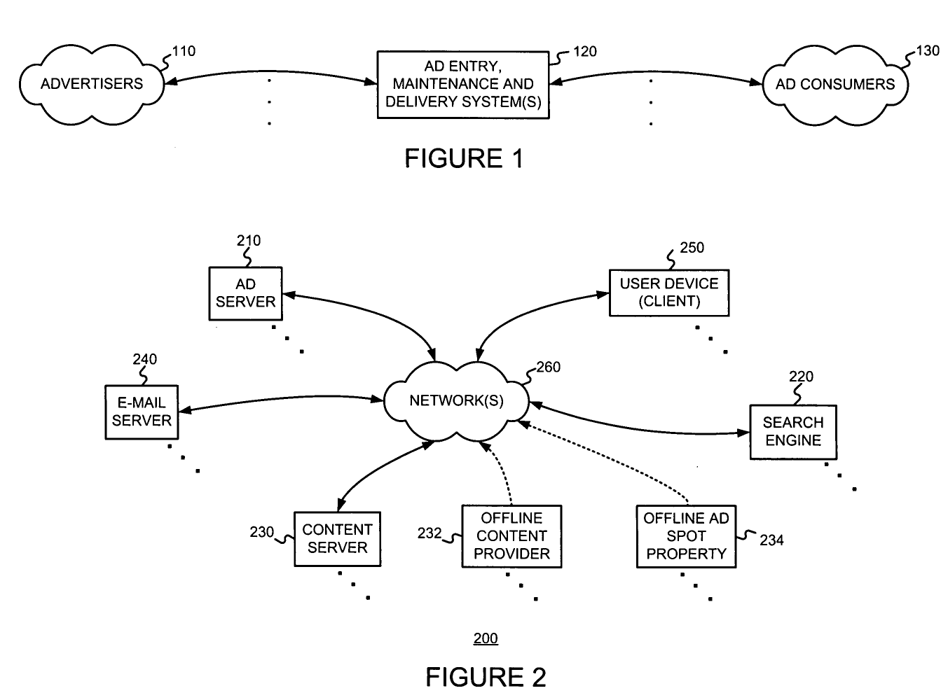

Online ads, such as those used in the exemplary systems described below with reference to FIGS. 1 and 2, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). Targeting criteria can be broad or narrow. For example, in some systems, an advertiser may be able to narrow the targeting of the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page. A Website may include multiple Web pages.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### § 4.2 Exemplary Advertising Environments in which, or with which, the Present Invention May Operate

FIG. 1 is a diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### § 4.3 EXEMPLARY EMBODIMENTS

Embodiments consistent with the present invention seek to improve online advertisement performance, end user experience, and/or advertising network branding. Embodiments consistent with the present invention seek to do so by determining when, where, and/or if to apply special logos, graphical elements, borders, and/or color schemes (referred to generally as “styles” or “styling”) to ads or a grouping of ads.

As discussed above, the AdWords advertising network has been used to target the serving of ads to search results generated by the Google search engine. In the past, the Google search engine home page has used special logos, often including various graphical elements to celebrate various special days.

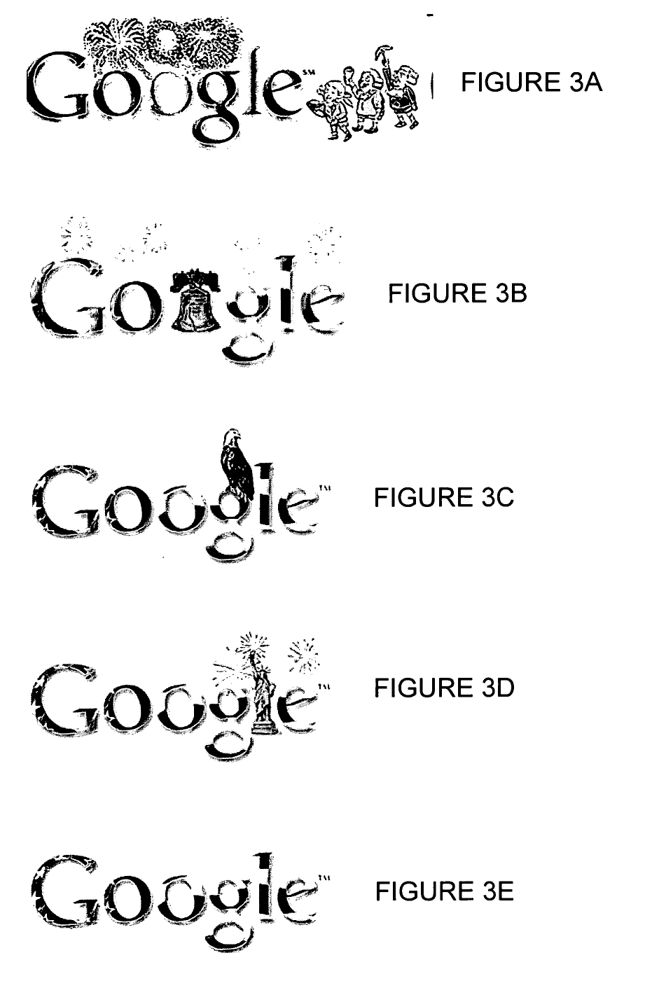

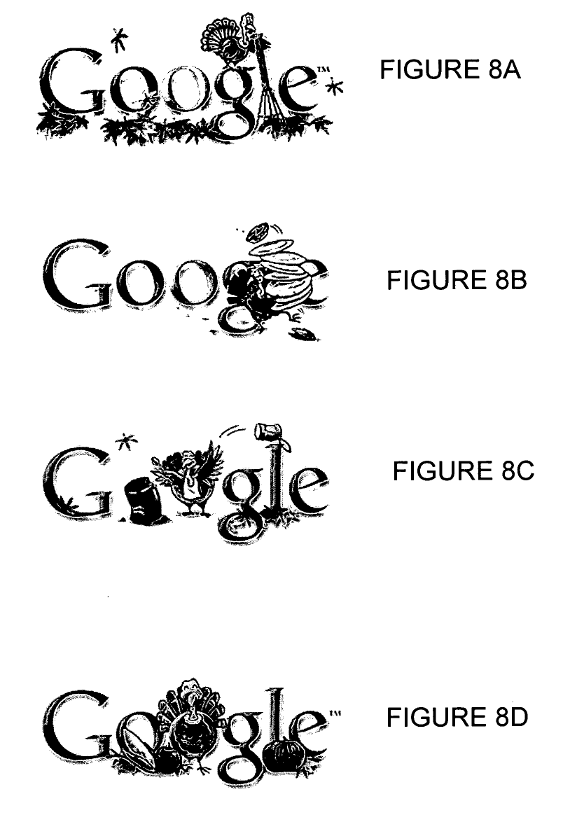

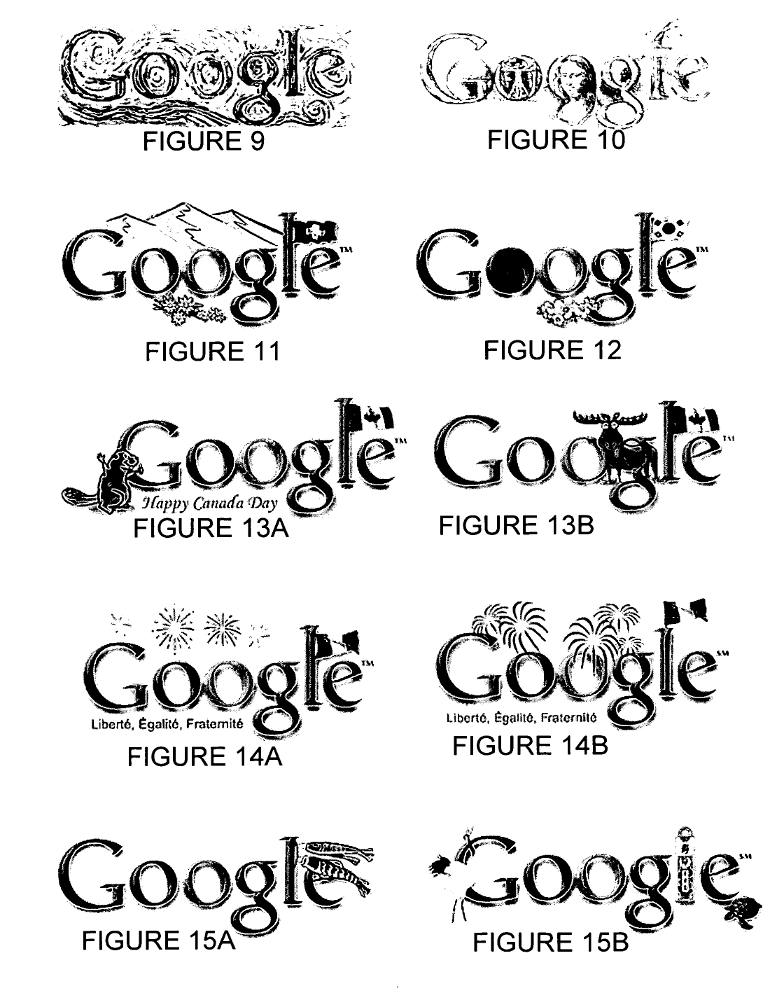

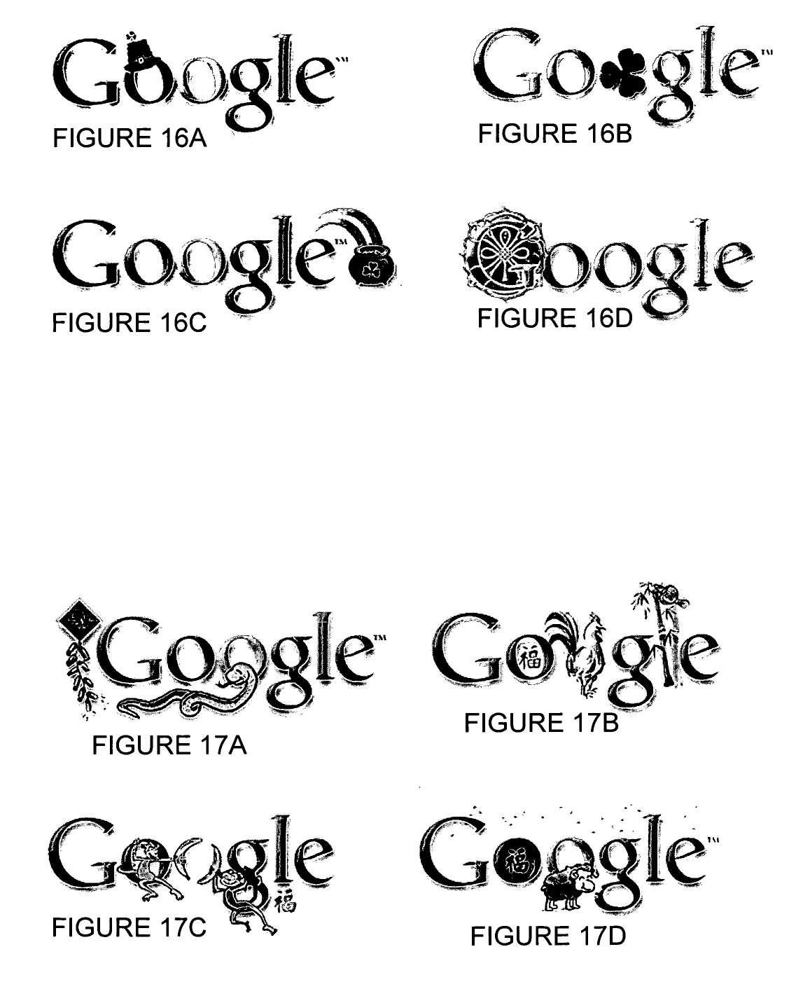

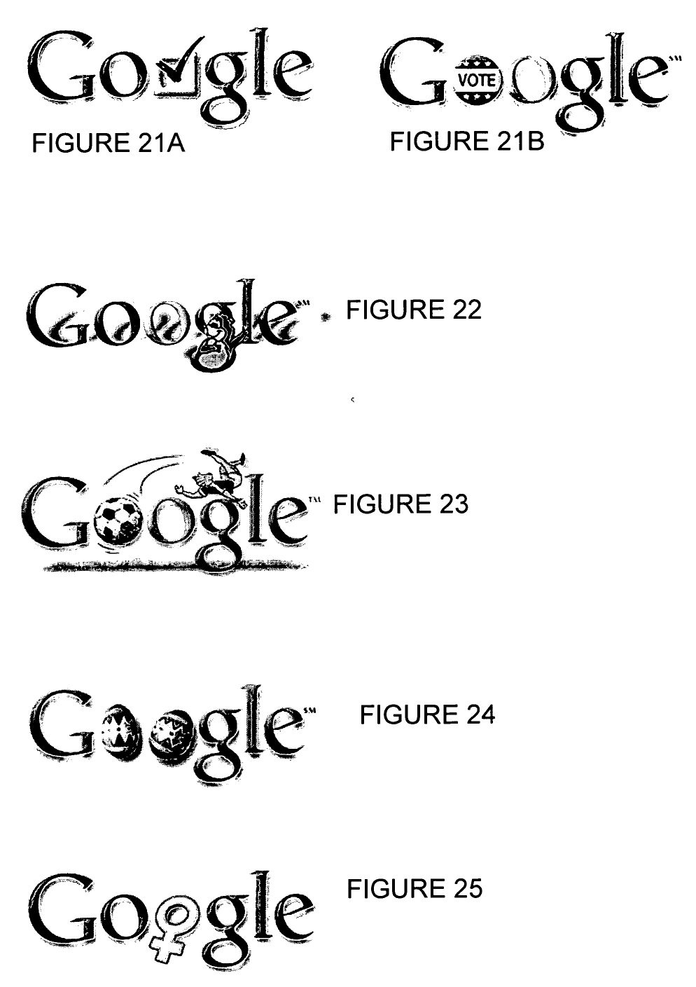

Some of these special logos pertain to special days in certain countries. For example, FIGS. 3A-3E are special logos that have been used on the Google search engine home page to celebrate America's Independence day, FIGS. 8A-8D are special logos that have been used on the Google search engine home page to celebrate Thanksgiving, FIG. 11 is a special logo that has been used on the Google search engine home page to celebrate Swiss National day, FIG. 12 is a special logo that has been used on the Google search engine home page to celebrate Korean Liberation day, FIGS. 13A and 13B are special logos that have been used on the Google search engine home page to celebrate Canada day, FIGS. 14A and 14B are special logos that have been used on the Google search engine home page to celebrate Bastille day, FIGS. 15A and 15B are special logos that have been used on the Google search engine home page to celebrate Children's day and Shichi-go-san day in Japan, FIGS. 16A-16D are special logos that have been used on the Google search engine home page to celebrate Saint Patrick's day, FIGS. 17A-17D are special logos that have been used on the Google search engine home page to celebrate Chinese New Years, FIGS. 21A and 21B are special logos that have been used on the Google search engine home page to encourage US voters to vote, FIG. 22 is a special logo that have been used on the Google search engine home page to celebrate Groundhog day. Note that some of these days are important in more than one country, particularly countries with a large immigrant population. For example, St. Patrick's day is not only celebrated in Ireland, but also in the United States. Similarly, Chinese New Years is not only celebrated in China, but also in the United States.

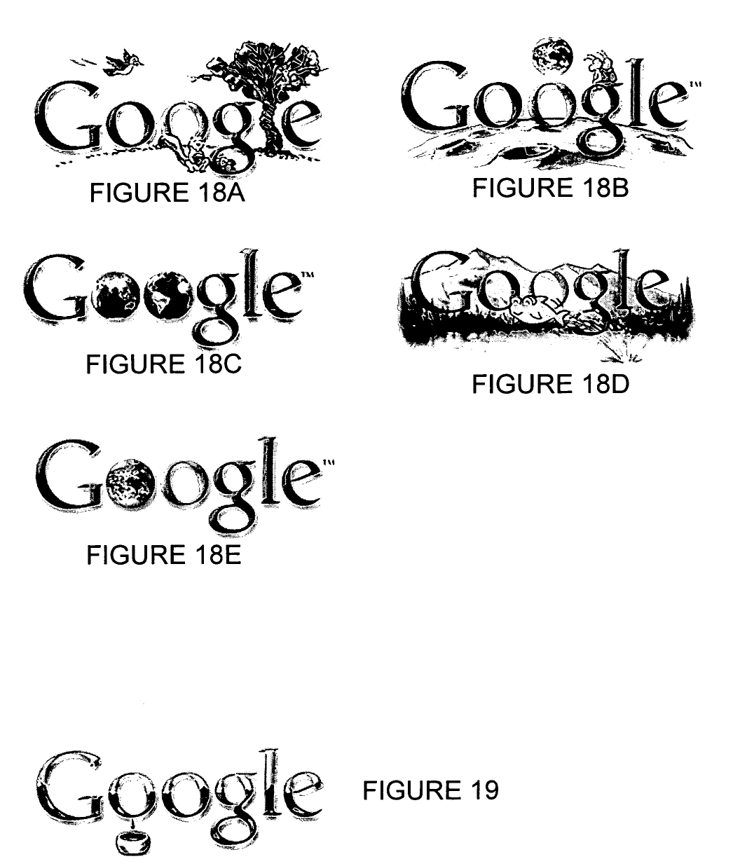

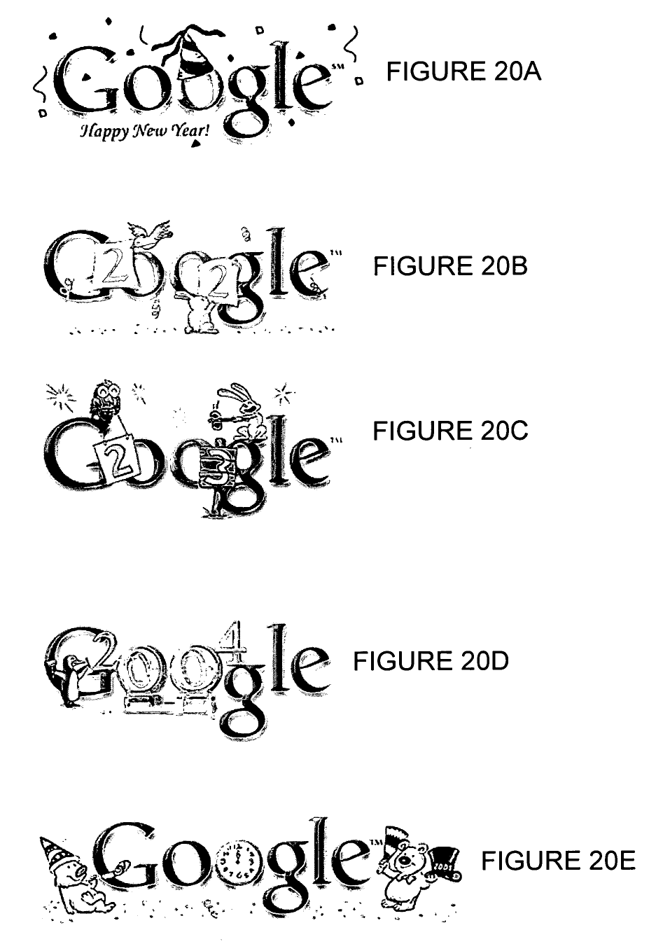

Some of the special logos pertain to days having an international or a large multi-national significance. For example, FIGS. 18A-18E are special logos that have been used on the Google search engine home page to celebrate Earth day, FIG. 19 is a special logo that has been used on the Google search engine home page to celebrate Water day, FIGS. 20A-20E are special logos that have been used on the Google search engine home page to celebrate New Year's day, FIG. 23 is a special logo that has been used on the Google search engine home page to celebrate the World Cup Soccer tournament, FIG. 24 is a special logo that has been used on the Google search engine home page to celebrate Easter, and FIG. 25 is a special logo that has been used on the Google search engine home page to celebrate International Woman's day. Note that some of these logos may be more important to certain individuals than others. For example, the World Cup Soccer tournament is more important to Soccer fans than others. As another example, International Women's day might be more important to Women than to men. Note further that some of these days have significance to certain religious groups, but not to others. For example, Easter is celebrated by Christians, but not other religious groups.

Some of the special logos celebrate individuals. For example, FIG. 9 is a special logo that has been used on the Google search engine home page to celebrate Vincent van Gogh's birthday, and FIG. 10 is a special logo that has been used on the Google search engine home page to celebrate Leonardo da Vinci's birthday. Note that these individuals may be more revered by people in certain countries, or certain nationalities, than others. For example, Italians may revere Leonardo da Vinci, while other groups might not (or at least, not to an as great degree). Similarly, the Dutch may revere Vincent van Gogh more than other groups.

Embodiments consistent with the present invention determine when (e.g., an appropriate date or dates), where (e.g., appropriate country or countries), and/or if (e.g., advertiser, content owner, and/or end user are appropriate) to apply special logos, graphical elements, borders, and/or color schemes (referred to generally as “styles” or “styling”) to ads or a grouping of ads.

Exemplary methods consistent with the present invention are described in § 4.3.1. Then, exemplary apparatus consistent with the present invention are described in § 4.3.2. Finally, refinements of, and alternatives to, the described methods and apparatus are described in § 4.3.3.

### § 4.3.1 Exemplary Methods

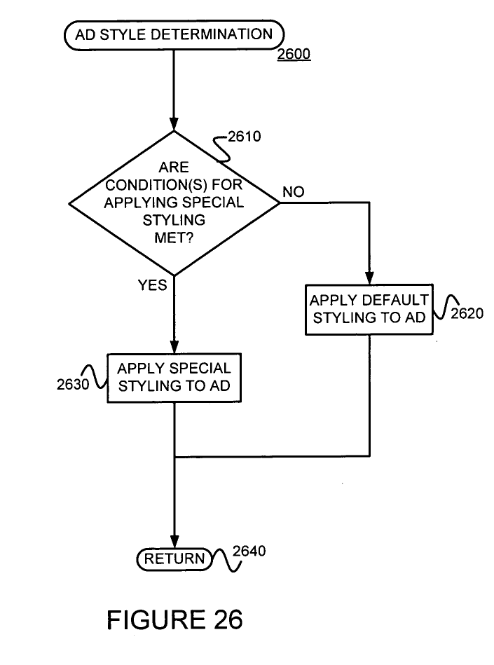

FIG. 26 is a flow diagram of an exemplary method 2600 for determining ad styles in a manner consistent with the present invention. As indicated in block 2610, it is determined whether or not one or more conditions for applying special styling are met (or a condition for special styling is met). If not, default styling (or some other normally determined style) is applied to an ad or ads (Block 2620) before the method 2600 is left (Node 2640). Referring back to block 2610, if, on the other hand, it is determined that condition(s) for applying special styling are met, then special styling may be applied to the ad or ads (Block 2630) before the method 2600 is left (Node 2640). Various exemplary techniques for determining whether or not conditions for special styling in a manner consistent with the present invention, as well as various techniques for applying special styling in a manner consistent with the present invention, are described in § 4.3.3 below.

### § 4.3.2 Exemplary Apparatus

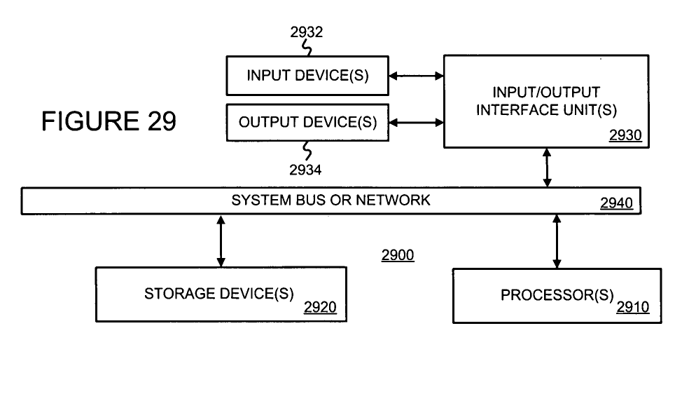

FIG. 29 is a block diagram of apparatus 2900 that may be used to perform at least some operations, and store at least some information (e.g., program instructions, rules, conditions, etc.), in a manner consistent with the present invention. The apparatus 2900 basically includes one or more processors 2910, one or more input/output interface units 2930, one or more storage devices 2920, and one or more system buses and/or networks 2940 for facilitating the communication of information among the coupled elements. One or more input devices 2932 and one or more output devices 2934 may be coupled with the one or more input/output interfaces 2930.

The one or more processors 2910 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 2920 and/or may be received from an external source via one or more input interface units 2930.

In one embodiment, the machine 2900 may be one or more conventional personal computers. In this case, the processing units 2910 may be one or more microprocessors. The bus 2940 may include a system bus. The storage devices 2920 may include system memory, such as read only memory (ROM) and/or random access memory (RAM). The storage devices 2920 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 2932, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 2910 through an appropriate interface 2930 coupled to the system bus 2940. The output devices 2934 may include a monitor or other type of display device, which may also be connected to the system bus 2940 via an appropriate interface. In addition to (or instead of) the monitor, the personal computer may include other (peripheral) output devices (not shown), such as speakers and printers for example.

Referring back to FIG. 2, one or more machines 2900 may be used as end user client devices 250, content servers 230, search engines 220, email servers 240, and/or ad servers 210.

### § 4.3.3 Refinements and Alternatives

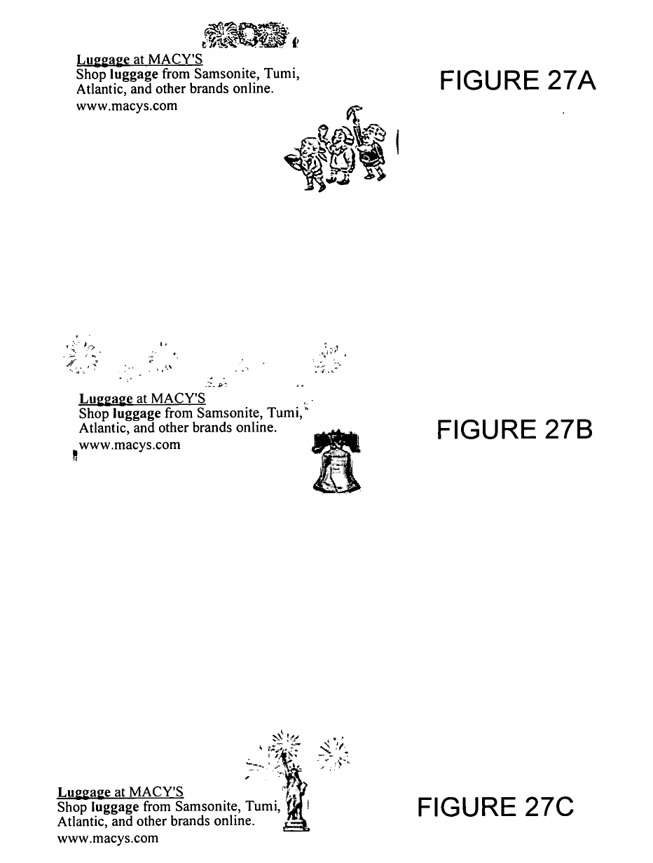

FIGS. 27A-27C illustrate examples of how different Independence Day graphical elements (e.g., icons) may be applied to ads. The ad of FIG. 27A is provided with graphical elements (signers of the Constitution and fireworks) shared with FIG. 3A. The ad of FIG. 27B is provided with graphical elements (the Liberty Bell and fireworks) shared with FIG. 3B. The ad of FIG. 27C is provided with graphical elements (the Statue of Liberty and fireworks) shared with FIG. 3D. As can be appreciated from these examples, graphical elements (e.g., icons) from a special logo provided on a search engine home page (such as that of Google) may be repeated in ads targeted to a search query entered via the search engine home page. This may be appreciated by end users, may increase ad performance (e.g., perception, selection rate, etc.), and/or may help end users associate quality ads (e.g., in terms of high relevancy) with quality search results (e.g., in terms of high relevancy).

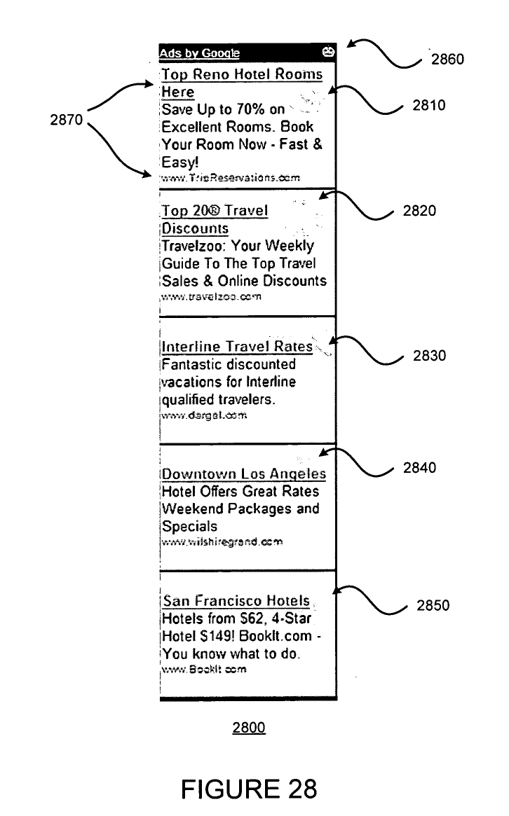

FIG. 28 illustrates examples of how different Halloween graphical elements may be applied as “watermarks.” A watermark may be a faded graphical element provided as an ad's background with ad creative content in the foreground.

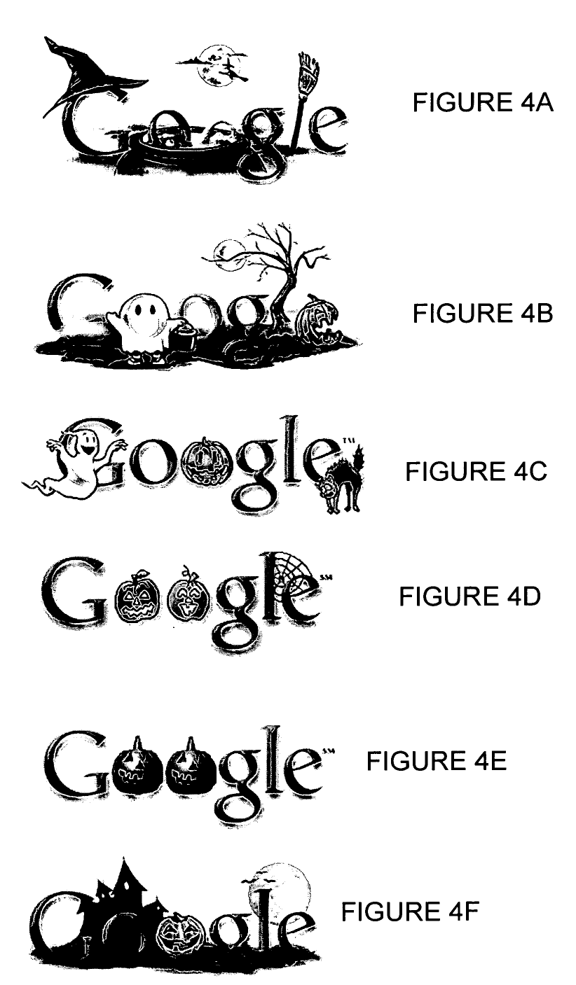

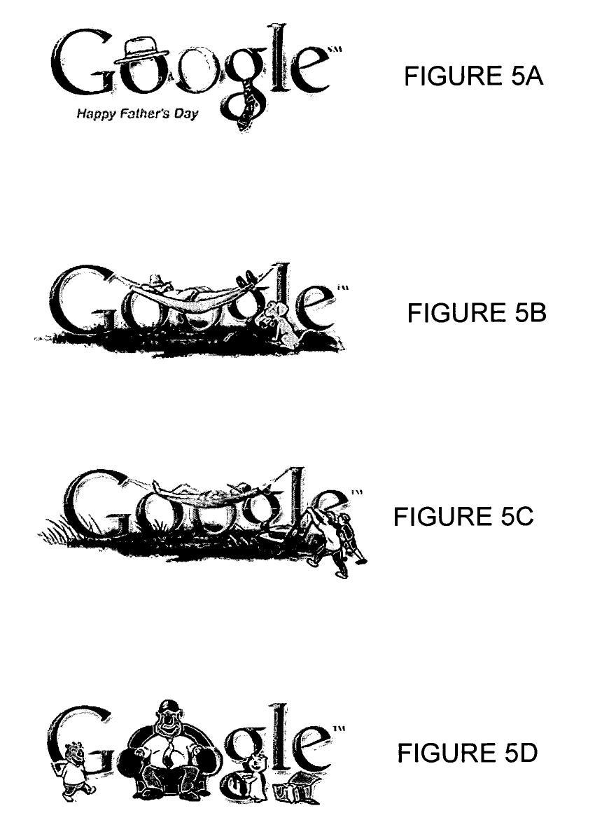

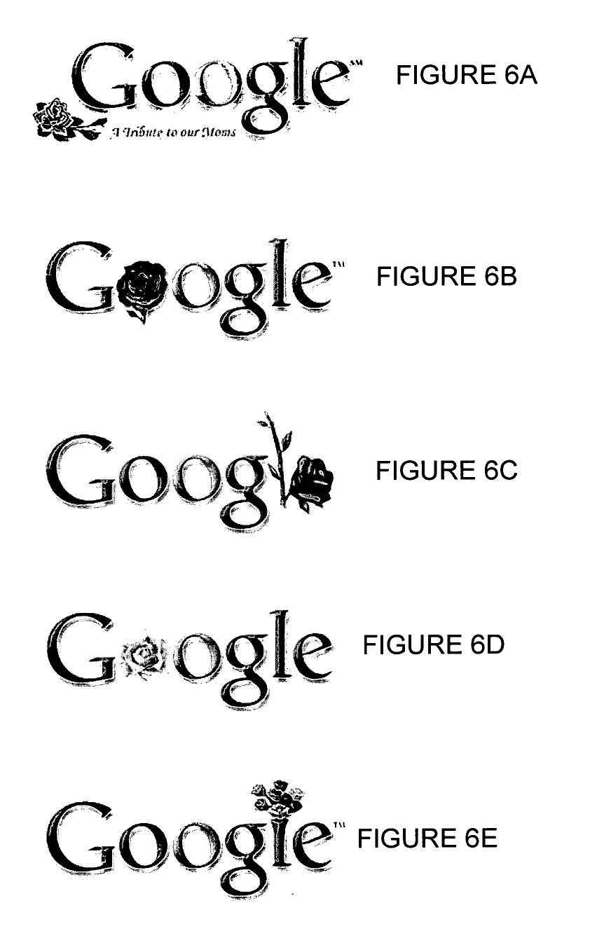

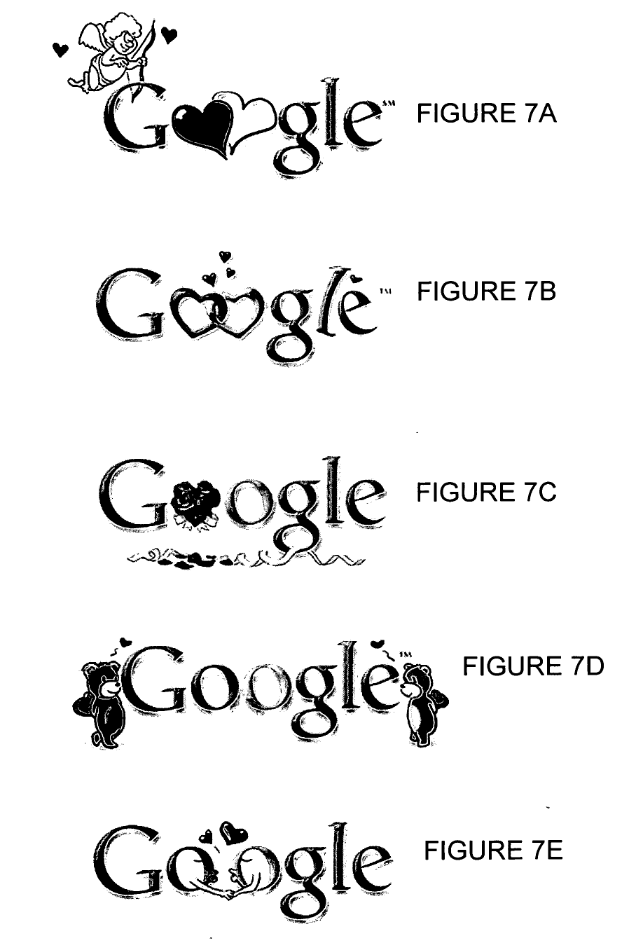

As shown, 2800 includes a set of five (5) ads, with a pumpkin graphical element 2860. The first (top) ad includes a pumpkin watermark graphical element 2810 which is also found in the logo of FIG. 4B. The second ad includes a ghost watermark graphical element 2820 which is also found in the logo of FIG. 4B. The third ad includes a flying witch watermark graphical element 2830 which is also found in the logo of FIG. 4A. The fourth ad includes a witch hat watermark graphical element 2840 which is also found in the logo of FIG. 4A. Finally, the last (bottom) ad includes a black cat watermark graphical element 2820 which is found in the logo of FIG. 4C. Although not evident in the black and white figures, parts of each of the ads, such as the title line and visible URL line 2870 are provided in orange, while other text is applied in black, as orange and black are colors associated with Halloween.

As can be appreciated from FIGS. 27 and 28, the special styling may be applied on a per-ad basis, and/or to a set of one or more ads (referred to as “an ad unit”).

Naturally, the present invention is not limited to the exemplary special styles. Examples of special styles include (a) providing graphical elements in association with an ad or a set of ads (e.g., at the periphery of an ad or a set of ads, within an attribute bar associated with an ad unit, etc.), (b) providing graphical elements (e.g., watermark icons) within an ad, (c) applying certain colors or color combinations to one or more portions of an ad or a set of ads (e.g., a border, text, etc.). Alternatively, or in addition, the special styles may include special audio elements. Alternatively, or in addition, the special styles may include video and/or animation elements.

The method 2600 of FIG. 26 may be performed at various times. For example, the special style (or default style) may be applied after a final set of ads to be served is determined. If the special style will affect the number of ads to be provided in an ad unit, or may affect the scoring of ads (e.g., if some advertisers offer to pay more for ad impressions with the special style (or selections or conversions on such ads)), the method 2600 (or at least a portion thereof), may be performed before a final set of ads to be served is determined. For example, in one exemplary embodiment consistent with the present invention, a request for an ad unit is received. Before an arbitration (e.g., auction) to determine a final set of ads for an ad unit, whether or not to apply special styling is determined (e.g., because sometimes a special style may require the arbitration to be run for a different number of ads, such as in the case where a large icon would occupy space normally reserved for an additional ad). The arbitration may then be performed to determine a number of ads. The act of determining whether or not to apply special styling may be performed again to ensure that the styling selected still makes sense given the number of ads chosen by the arbitration. For example, if no ads are returned, it may be beneficial to use some different style. The proper HTML markup (to generate the proper style) is returned to the end user's browser. Each style is basically a template with placeholders waiting to be filled by different parts of several ads. The various ad text are placed into their respective placeholders and the result is returned. Naturally, the present invention is not limited to this particular embodiment.

Recall from block 2610 of FIG. 26 that it is determined whether one or more conditions for special styling are met. Conditions may be related to the date on which the ad is to be served, the location of the advertiser, the location of the end user to which (or client device on which) the ad is to be served, the location or top level domain (e.g., .com, .es, .fr, etc.) of an entity with whose content the ad is to be served (e.g., a Web publisher), preferences expressed by or inferred about the advertiser, preferences expressed by or inferred about the end user, preferences expressed by or inferred about a content owner (e.g., a Web publisher), information about the advertiser, information about the end user, information about the content owner, etc. These conditions may be applied alone, or in concert (e.g., in a logical OR manner under which the special styling is applied if any conditions are met, in a logical AND manner under which the special styling is applied only if all (or a subset of all) conditions are meet, etc.).

As an example of conditioning the application of special styling on a date, consider that it might be desirable to apply special styling for America's Independence day only on July 4.

As an example of conditioning the application of special styling on a location of the advertiser, consider that it might be desirable to apply special styling for Bastille day to a French advertiser. Similarly, as an example of conditioning the application of special styling on a location of an end user, it might be desirable to apply special styling for Canada day to an end user (e.g., working on a client device) located in Canada. As yet another example, it might be desirable to apply special styling for Canada day to a content owner (e.g., web publisher) in located in (or having a substantial business presence in) Canada.

As an example of conditioning the application of special styling on preferences expressed by or inferred about the advertiser, if the advertiser has selected a custom color scheme or custom elements, it might be desirable to not apply a special style that would obviate, obscure, and/or dilute such advertiser selections.

As an example of conditioning the application of special styling on preferences expressed by or inferred about the end user, if the end user has selected to not install code to enable animation such as flash animation, it might desirable to not apply a special style that includes an animation (even if it could be run on an enabled technology). As another example, if the end user is not Christian, it might be desirable to not apply a special style celebrating Easter.

As an example of conditioning the application of special styling on preferences expressed by or inferred about a content owner (e.g., a Web publisher), if a Web publisher (e.g., participating in AdSense by Google) has selected a custom color scheme to be applied to ads served on its Website (e.g., to maintain a consistent image or look-and-feel), it might be desirable to not apply a special style that would obviate, obscure, and/or dilute such Web publisher selections. As another example, if a content owner has opted into displaying image ads, it might be desirable to apply a special styling to ads served on its content.

As an example of conditioning the application of special styling on information about the advertiser, if the advertiser is opposed to Halloween (e.g., on religious grounds), it might be desirable not to apply a special style celebrating Halloween to ads of that advertiser.

As an example of conditioning the application of special styling on information about the end user, if the end user is not Chinese, it might be desirable not to apply a special style celebrating the Chinese New Year. Similarly, it might be desirable not to provide ads with special styling including colors or images that are associated with bad luck, or that have a negative association in certain cultures to which the end user may belong.

Finally, as an example of conditioning the application of special styling on information about the content owner, if the content owner is a Website for widows or single mothers, it might not be desirable to apply a special style celebrating Fathers Day.

Various information upon which the application of special styling is conditioned may be known or inferred. For example, the language used by a user may indicate the country in which the user resides, and/or their nationality. As another example, the use of a “family friendly” filter may indicate that the user has children.

In at least some embodiments consistent with the present invention, an advertiser may opt out of (or opt into) having their ads provided with special styling. The opting out of (or into) may be on a general basis (across all special styling), across groups of special styling (e.g., all special styling concerning religious holidays or celebrations), or to specific special styling (e.g., opt out of Halloween special styling and World Soccer Tournament special styling only).

Similarly, in at least some embodiments consistent with the present inventions, a content owner (e.g., a Web publisher on whose Website ads are to be shown) may opt out of (or into) having ads with special styling shown on their content (e.g., Website).

In at least some embodiments consistent with the present invention, special styling may be applied only to ads with a score exceeding a certain level, or having a factor (such as selection rate, offer, etc.) that exceeds a certain level. In this regard, techniques described in the '350 application may be used in a manner consistent with the present invention.

In at least some embodiments consistent with the present invention, ads of an advertiser might be applied with special styles only if the advertiser agrees to pay a surcharge (e.g., a flat fee, a percentage of their maximum offer, a percentage of a discounted price, etc.).

In at least some embodiments consistent with the present invention, the condition upon which the application of special styling depends may be whether a “special styling score” exceeds a threshold. The special styling score may be a function of one or more of the factors (e.g., conditions) discussed above.

Although many of the examples concern a special date, embodiments consistent with the present invention may apply special styling associated with a special event.

### § 4.4 CONCLUSIONS

As can be appreciated from the foregoing, embodiments consistent with the present invention can be used to improve end user's enjoyment of online ads, increase a likelihood that an end user will notice an ad, increase performance (e.g., selection rate) of an ad, increase brand association between an advertising network and an ad, increase brand association between a search engine and an ad, increase brand association between a Webpage and an ad, etc.

What is claimed is:

1. A computer-implemented method comprising:
a) determining whether or not one or more conditions are met for the application of special styling to an ad; and
b) applying the special styling to the ad only if the one or more conditions are met.

2. The computer-implemented method of claim 1 wherein the condition is at least one of (A) an advertiser associated with the ad being in a certain location, and (B) an advertiser associated with the ad not being in a certain location.

3. The computer-implemented method of claim 1 wherein the condition is at least one of (A) an end user to which the ad is to be rendered being in a certain location, and (B) an end user to which the ad is to be rendered not being in a certain location.

4. The computer-implemented method of claim 1 wherein the condition is at least one of (A) an advertiser associated with the ad having a certain preference, and (B) an advertiser associated with the ad not having a certain preference.

5. The computer-implemented method of claim 1 wherein the condition is at least one of (A) an end user to which the ad will be rendered having a certain preference, and (B) an end user to which the ad will be rendered not having a certain preference.

6. The computer-implemented method of claim 1 wherein the condition is at least one of (A) a content owner with whose content the ad is to be rendered having a certain preference, and (B) a content owner with whose content the ad is to be rendered not having a certain preference.

7. The computer-implemented method of claim 6 wherein the content owner is a Web publisher.

8. The computer-implemented method of claim 1 wherein the condition is at least one of (A) a content owner with whose content the ad is to be rendered being in a certain location, and (B) a content owner with whose content the ad is to be rendered not being in a certain location.

9. The computer-implemented method of claim 1 wherein the condition is that the date is a predetermined date.

10. The computer-implemented method of claim 9 wherein the date is selected from a group of dates consisting of (A) New Years day, (B) Martin Luther King's Birthday, (C) Presidents' Birthday, (D) Columbus Day, (E) Chinese New Years day, (F) Valentines Day, (G) Arbor Day, (H) Saint Patrick's Day, (I) Memorial Day, (J) Mother's Day, (K) Father's Day, (L) Halloween, (M) All Saints Day, (N) Thanksgiving Day, (O) Independence Day, (P) Labor Day, (Q) Christmas day, (R) Carnaval, (S) Victoria Day, (T) Boxing Day, (U) a federal holiday, (V) a national holiday, and (W) Earth Day.

11. The computer-implemented method of claim 1 wherein the special styling includes a graphical element.

12. The computer-implemented method of claim 1 wherein the special styling includes an animation element.

13. The computer-implemented method of claim 1 wherein the special styling includes a watermark graphical element.

14. The computer-implemented method of claim 13 wherein the watermark graphical element is a faded graphical element provided on an ad background with ad creative content in the foreground.

15. The computer-implemented method of claim 1 wherein the special styling includes a color scheme.

16. The computer-implemented method of claim 1 wherein the condition is an end user to which the ad is to be rendered using a certain language.

17. A computer-readable medium having stored thereon at least one computer readable condition, including a date condition, upon which the application of special styling to an advertisement is conditioned.

18. A computer-implemented method comprising:
a) providing a search engine Web page including a date-dependent graphical element;
b) generating search results responsive to a search query entered on the search engine Web page;
c) generating a set of one or more ads, wherein the set of one or more ads is determined, at least in part, using information in the entered search query, wherein the set of one or more ads includes a second graphical element with at least one feature in common with the date-dependent graphical element; and
d) generating a Web page including the generated search results and the generated set of one or more ads.

19. The computer implemented method of claim 18 wherein at least one common feature of the second graphical element and date dependent graphical element is an icon.

20. The computer implemented method of claim 18 wherein at least one common feature of the second graphical element and date dependent graphical element is an item associated with the date.

21. A computer-implemented method comprising:
a) generating a set of one or more ads, wherein the set of one or more ads is determined, at least in part, using information related to content of a document, wherein the set of one or more ads includes a first date dependent graphical element; and
b) generating an instance of the document including (1) the content, (2) the generated set of one or more ads, and (3) a second date-dependent graphical element, wherein the first and second date-dependent graphical elements include at least one feature in common.

22. The computer implemented method of claim 21 wherein at least one common feature of the second graphical element and date dependent graphical element is an icon.

23. The computer implemented method of claim 21 wherein at least one common feature of the second graphical element and date dependent graphical element is an item associated with the date.

24. Apparatus comprising:
a) means for determining whether or not one or more conditions are met for the application of special styling to an ad; and
b) means for applying the special styling to the ad only if the one or more conditions are met.
